(19) United States
(12) Patent Application Publication
(10) Pub. No.: US 2002/0138305 A1
(43) Pub. Date: Sep. 26, 2002

(54) Drug information processing device, medical record recording device, drug information providing system, drug information processing program storage medium, and medical record recording program storage medium

(75) Inventors: Youichi Watanabe, Kawasaki (JP); Toshihisa Yamaguchi, Kawaski (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/101,832

(22) Filed: Mar. 21, 2002

(30) Foreign Application Priority Data
Mar. 26, 2001 (JP) 2001-88001

(51) Int. Cl. G06F 17/60

(52) U.S. Cl. 705/2

(57) ABSTRACT

A drug information processing device suitable for collecting medical results information by a pharmaceutical supplier, a medical record recording device suitable for obtaining drug information by a medical institution, and a drug information providing system. There are provided a medical results information updating unit which is connected through a communication line to a medical record recording device being installed at a medical institution site and recording a medical record prepared by a medical person in charge, and which is provided with medical results information about a drug used in the medical institution where the medical record recording device is installed among the medical records recorded in the medical record recording device, and which performs processing of the medical results information provided and a point calculation unit, and a point information updating unit giving evaluation points to the medical institution based on the medical results information provided from the medical institution.

### BACKGROUND OF THE INVENTION

1. Field of the Invention

The present invention relates to a drug information processing device for providing a medical record recording device with drug information, a medical record recording device for providing a drug information processing device with medical results information, a drug information providing system comprising the drug information processing device and the medical record recording device, a drug information processing program storage medium storing a drug information processing program, and a medical record recording program storage medium storing a medical record recording program.

2. Description of the Related Art

Recently, the number of medical institutions, which use medical record recording devices for electronically recording medical records prepared by doctors, has been increasing. The medical record is a document in which medical results information including curative effects and side effects of drugs used for treatments of patients, thus the medical results information becomes an extremely important information source for medical representatives of pharmaceutical manufacturers developing new drugs or of pharmaceutical sales companies etc.

Consequently, in order to collect the medical results information including curative effects and side effects of the new drugs etc. used in the medical institutions, an MR (a Medical Representative) of a pharmaceutical supplier such as a pharmaceutical manufacturer or a pharmaceutical sales company directly visits the medical institution to meet the doctor and collects the medical results information about the drug by meeting and asking the doctor to write the medical results information in a form which is called a questionnaire on use results.

On the other hand, the medical institutions desire to promptly obtain information about new drugs immediately after the development thereof. As a measure of obtaining such information, a medical institution obtains the drug information about the efficacy, side effects, drug interactions or the like of the new drugs etc. when an MR from a pharmaceutical supplier who visits the medical institution directly meets the doctor. This becomes one of the important routes for the doctors to obtain such information.

However, when the pharmaceutical supplier collects the medical results information required for developing new drugs through the above described way, there are some problems such that the MR has to expend enormous efforts to coordinate the time schedule of visiting doctors because of limited time for directly meeting the doctors to explain information about the new drugs and also the pharmaceutical supplier has to earmark a large amount of personnel costs.

In addition, when a doctor at the medical institution prepares the medical results information, there is a problem such that the doctor has to search for a medical record regarding a drug used for a treatment in order to collect the medical results information, thus this work becomes burdensome to the doctor, for example.

Also, when the doctor at the medical institution obtains information about a new drug, there are presently no preferable routes for efficiently obtaining such information except for relying on the above described route from the MR, so that it is difficult to promptly obtain the latest drug information.

An object of the present invention, in view of the above described circumstances, is to provide a drug information processing device suitable for collecting medical results information by a pharmaceutical supplier, a medical record recording device suitable for obtaining drug information by a medical institution, a drug information providing system, a drug information processing program storage medium storing a drug information processing program, and a medical record recording program storage medium storing a medical record recording program.

### SUMMARY OF THE INVENTION

A drug information processing device according to the present invention for achieving the above described object, which is connected through a communication line to a medical record recording device being installed at a medical institution site and recording medical records prepared by a medical person in charge comprises: a medical results information processing unit which is provided with medical results information about a drug used in the medical institution where the medical record recording device is installed among the medical records recorded in the above described medical record recording device and which performs processing of the medical results information provided; and an evaluation point giving unit giving evaluation points to the medical institution based on the medical results information provided from the above described medical institution.

In this case, it is preferable that the above described medical record recording device is adapted such that the use right of using the medical record recording device is given to the medical institution in which the medical record recording device is installed on a temporary basis, and that the above described drug information processing device comprises a use right expiration managing unit managing an expiration date of the use right of using the medical record recording device acquired by the medical institution in which the above described medical record recording device is installed, the use right expiration managing unit renewing the expiration date of the above described use right based on an accumulated value of evaluation points given to the above described medical institution by the above described evaluation point giving unit.

It is also a preferable aspect that the above described drug information processing device comprises a use right recording database recording the expiration date of the use right of using the medical record recording device for every medical institution, and that the above described use right expiration managing unit automatically updates the expiration date being recorded in the above described use right recording database when the above described use right expiration managing unit renews the above described expiration date of the use right.

In addition, it is also one of the preferable aspects that the above described drug information processing device comprises a point set database previously setting a giving condition of evaluation points for every drug, and a point calculation unit calculating the evaluation points based on the giving condition of evaluation points stored in the point set database and a providing condition of medical results information provided from the medical institution.

A medical record recording device according to the present invention for achieving the above described object, which is installed at a medical institution site and records a medical record prepared by a medical person in charge in a predetermined medical record database, connected through a communication line to a drug information processing device being installed at a pharmaceutical supplier site and for providing the medical institution with drug information about a drug comprises a drug information acquiring and displaying unit for automatically acquiring drug information about a new drug from the above described drug information processing device and then displaying the acquired information on a screen.

In this case, it is preferable that the above described drug information acquiring and displaying unit acquires and displays drug information about a drug which has been used in the above described medical institution and a drug which has been recently purchased by the medical institution.

Also, it is a preferable aspect that the above described drug information acquiring and displaying unit acquires and displays drug information other than drug information about a new drug which has already been used in the above described medical institution.

In addition, it is also one of the preferable aspects that the above described medical record recording device has an evaluation point reference unit making reference to evaluation points given from the above described evaluation point giving unit to the medical institution.

A drug information providing system according to the present invention for achieving the above described object comprises a medical record recording device being installed at a medical institution site and recording a medical record prepared by a medical person in charge in a predetermined medical record database as well as providing a pharmaceutical supplier with medical results information about a drug used in the medical institution among medical records recorded in the above described medical record database and a drug information processing device, which is installed at a pharmaceutical supplier site and is connected through a communication line to the above described medical record recording device, having an evaluation point giving unit giving evaluation points to the medical institution based on the medical results information provided from the above described medical record recording device.

In this case, it is preferable that the above described medical record recording device comprises a drug information acquiring and displaying unit automatically acquiring drug information about a new drug from the above described drug information processing device and then displaying the acquired information on a screen, and that the above described evaluation point giving unit gives evaluation points to the above described medical institution each time the above described drug information acquiring and displaying unit acquires and displays the drug information about the new drug from the above described drug information processing device.

Also, it is a preferable aspect that the above described medical record recording device comprises a medical record input unit inputting a medical record including the above described medical results information in order to record the medical record in the above described medical record database and has a drug information selecting unit displaying drug information provided from the above described drug information processing device on a screen as well as selecting a drug name to be input from the displayed drug information when the medical results information is input by the above described medical record input unit, and the above described drug information selecting unit displays whether or not the drug displayed on the screen is a drug to be a subject of point giving performed by the above described evaluation point giving unit.

In addition, it is also one of the preferable aspects that the above described drug information processing device has a condition information transmitting unit transmitting condition information describing conditions about medical results information required from a pharmaceutical supplier to the above described medical record recording device, and that the above described medical record recording device has a subject patient extracting and displaying unit extracting a patient to be a subject of the medical results information from the above described medical record database based on the condition information transmitted from the above described condition information transmitting unit and then displaying the information about the extracted subject patient on a screen.

Further, it is also one of the preferable aspects that the above described drug information processing device has a medical results format transmitting unit transmitting a format of medical results information which should be prepared by the above described medical record recording device to the medical record recording device, and the above described medical record recording device has a format conversion correspondence database converting the format of medical results information transmitted from the above described medical results format transmitting unit into a format for the above described medical results database, and has a medical results information generating unit editing the medical record recorded in the above described medical record database and then generating the medical results information based on the format of medical results information transmitted from the above described medical results format transmitting unit and the above described format conversion correspondence database.

A drug information processing program storage medium according to the present invention for achieving the above described object stores a drug information processing program, in which the drug information processing program is run on a computer connected through a communication line to a medical record recording device being installed at a medical institution site and recording medical records prepared by a medical person in charge, the computer is operated as a drug information processing device comprising a medical results information processing unit provided with medical results information about a drug used in the medical institution where the medical record recording device is installed among medical records recorded in the above described medical record recording device and carrying out processing of the provided medical results information, and an evaluation point giving unit giving evaluation points to the medical institution based on the medical results information provided from the above described medical institution.

A medical record recording program storage medium according to the present invention for achieving the above described object stores a medical record recording program in which the medical record recording program is run on a computer connected through a communication line to a drug information processing device being installed at a pharmaceutical supplier site and providing a medical institution with drug information about a drug and the computer is operated as a medical record recording device being installed at the medical institution site and recording medical records prepared by a medical person in charge in a predetermined medical record database, the medical record recording program having a drug information acquiring and displaying unit for automatically acquiring drug information about a new drug from the above described drug information processing device and then displaying the acquired information on a screen.

### BRIEF DESCRIPTION OF THE DRAWINGS

FIG. 1 shows a part of a computer system for operating a drug information providing system of an embodiment according to the present invention;

FIG. 2 is a block diagram showing a hardware configuration of the computer system whose appearance is shown in FIG. 1;

FIG. 3 is a schematic block diagram showing an embodiment of a drug information processing device, a medical record recording device, and a drug information providing system according to the present invention;

FIG. 4 shows a file structure of a point set database in this embodiment;

FIG. 5 shows a file structure of a point results database at a pharmaceutical manufacturer site;

FIG. 6 shows a file structure of a point results database at a medical institution site;

FIG. 7 shows a file structure of a medical results database 18 in this embodiment;

FIG. 8 is a flowchart showing a process flow from the preparation of medical results information to the collection of the medical results information by the drug information processing device;

FIG. 9 is a flowchart showing a process flow from the preparation of medical results information to the collection of the medical results information by the drug information processing device;

FIG. 10 is a flowchart showing a process flow from the preparation of medical results information to the collection of the medical results information by the drug information processing device;

FIG. 11 shows a file structure of a format conversion correspondence database of this embodiment;

FIG. 12 shows a file structure of a test results database in this embodiment;

FIG. 13 is a flowchart showing a process for matching the point results database at the pharmaceutical manufacturer site to the point results database at the medical institution site;

FIG. 14 is a flowchart showing a process when an expiration date of the right to use the medical record recording device is renewed based on the evaluation points;

FIG. 15 is a file structure of a drug database 15 in this embodiment;

FIG. 16 is a file structure of a drug master provided in the medical record recording device of this embodiment;

FIG. 17 is a flowchart of acquiring the drug information by the medical record recording device of this embodiment;

FIG. 18 is a flowchart showing a process for displaying the drug information at the medical record recording device of this embodiment;

FIG. 19 is a file structure of the medical record database in this embodiment;

FIG. 20 is an example of a drug list displaying screen which is displayed by a drug information selecting unit of this embodiment;

FIG. 21 is a block diagram showing a drug information processing program stored in a drug information processing program storage medium of this embodiment; and

FIG. 22 is a block diagram showing a medical record recording program stored in a medical record recording program storage medium of this embodiment.

### DETAILED DESCRIPTION OF THE PREFERRED EMBODIMENTS

Now, an embodiment of the present invention will be described below.

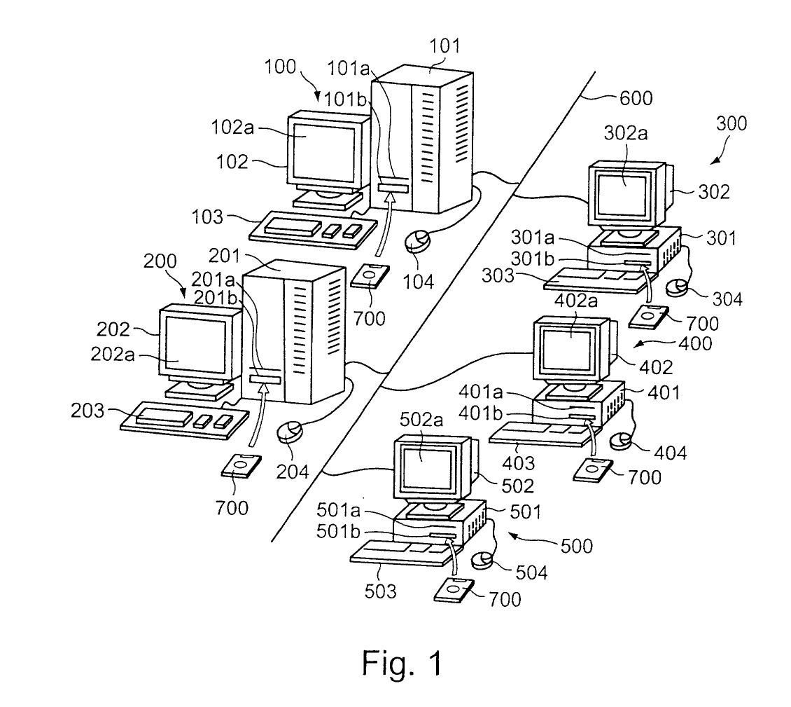

FIG. 1 shows a part of a computer system for operating a drug information providing system of an embodiment according to the present invention.

Five computer systems 100, 200, 300, 400, and 500 are illustrated in FIG. 1, and for example, two computer systems 100 and 200 are configured as medical information processors of the present invention while three computer systems 300, 400, and 500 are configured as medical record recording devices of the present invention.

All of these computer systems 100, 200, 300, 400 and 500 are connected through a communication line 600. The communication line may be an external network such as the WWW (the Internet), a LAN (a Local Area Network) or a WAN (a Wide Area Network).

The computer systems 100, 200, 300, 400, and 500 comprise: system units 101, 201, 301, 401, and 501 containing CPUs (central processing units), RAMs (random access memories), hard disks, and communication boards; displaying units 102, 202, 302, 402, and 502 for displaying images or character strings on display screens 102a, 202a, 302a, 402a, and 502a following instructions from the system units 101, 201, 301, 401, and 501; keyboards 103, 203, 303, 403, and 503 for inputting instructions of users to the computer systems 100, 200, 300, 400, and 500; and mice 104, 204, 304, 404, and 504 for specifying any positions on the display screens 102a, 202a, 302a, 402a, and 502a to input instructions corresponding to icons etc. displayed on the positions at the specified time, respectively.

The system units 101, 201, 301, 401, and 501 outwardly have FD loading ports 101a, 201a, 301a, 401a, and 501a into which FDs (floppy disks: not shown) are loaded and MO loading ports 101b, 201b, 301b, 401b, and 501b into which MOs (magneto-optical disks) 700 are loaded respectively, and a floppy disk driver and an MO driver for driving and accessing the floppy disk and the MO 700 loaded from the loading ports are also built into an interior of respective loading ports.

Next, the computer system 100 will be described only by way of example.

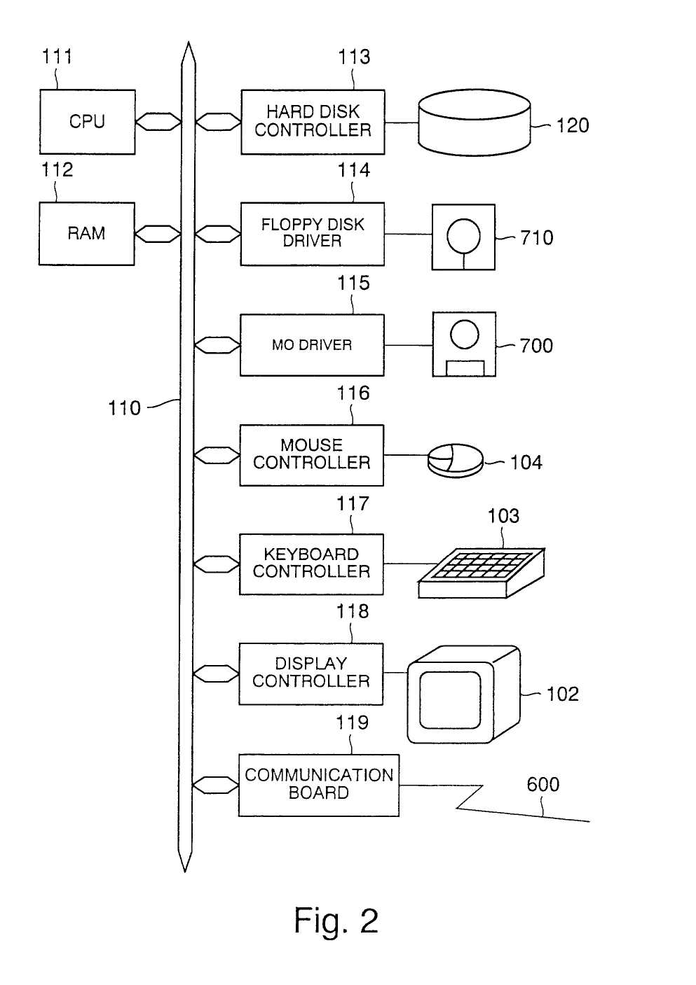

FIG. 2 is a block diagram of a hardware configuration of the computer system 100 whose appearance is shown in FIG. 1.

This block diagram shows a CPU 111, a RAM 112, a hard disk controller 113, a floppy disk driver 114, an MO driver 115, a mouse controller 116, a keyboard controller 117, a display controller 118, and a communication board 119, all of which are connected through a bus 110.

The floppy disk driver 114 and the MO driver 115 into which a floppy disk 710 and the MO 700 are loaded respectively are for making access to the loaded floppy disk 710 and MO 700, as described with reference to FIG. 1.

The communication board 119 is connected to a communication line 600.

FIG. 2 also shows a hard disk 120 to be accessed by the hard disk controller 113, a mouse 104 controlled by the mouse controller 116, a keyboard 103 controlled by the keyboard controller 117, and a CRT display 102 controlled by the display controller 118.

A drug information processing device, a medical record recording device, and a drug information providing system according to the present invention are constructed and operated on the above described computer system.

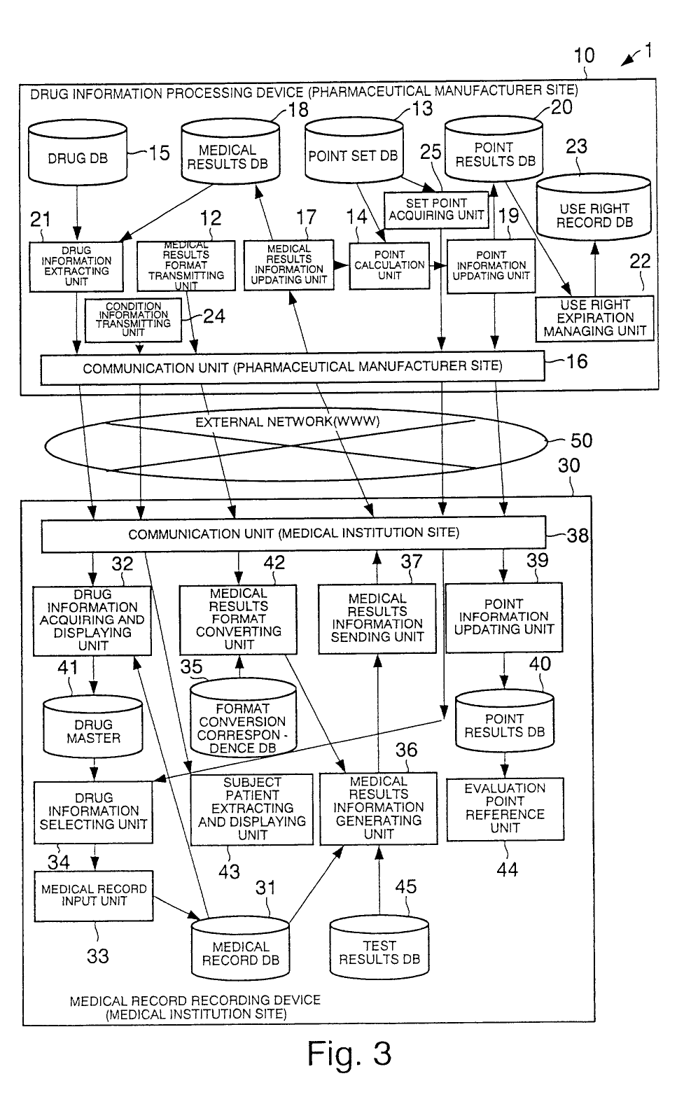

FIG. 3 is a schematic block diagram showing an embodiment of a drug information processing device, a medical record recording device, and a drug information providing system according to the present invention.

First, a drug information processing device 10 according to this embodiment will be described with reference to FIG. 3.

The drug information processing device 10 of this embodiment connected through a communication line 50 to a medical record recording device 30 being installed at a medical institution site and for recording medical records prepared by a medical person in charge, and comprises: a medical results information updating unit 17 and a point calculation unit 14 provided with medical results information about a drug used by the medical institution in which the medical record recording device is installed among medical records recorded to the medical record recording device 30 in order to perform processing of the provided medical results information; and a point information updating unit 19 for giving evaluation points to the medical institution based on the medical results information provided from the medical institution.

The drug information processing device 10 at a pharmaceutical supplier site and the medical record recording device 30 at the medical institution site comprise a communication unit 16 and a communication unit 38 respectively, and the communication unit 16 at a pharmaceutical supplier site and the communication unit 38 at the medical institution site are connected to each other through the communication line 50 so that information can be transmitted between them.

The medical results information updating unit 17 and the point calculation unit 14 of this embodiment correspond to a medical results information processor according to the present invention, while the point information updating unit 19 of this embodiment corresponds to an evaluation point giving unit according to the present invention.

The pharmaceutical supplier in the present invention includes any persons and organizations who supply drugs to the medical institutions such as pharmaceutical sales companies in addition to the pharmaceutical manufacturers of this embodiment.

As shown in FIG. 3, the above described medical results information is generated by a medical results information generating unit 36 according to operation made by a doctor at the medical institution site based on the medical records recorded in a medical record database 31 and the test results, which are obtained in the medical institution or in some subcontracting test centers, recorded in a test results database 45 in the medical record recording device 30, and then the generated information is sent to the medical results information updating unit 17 through the communication unit 38 at the medical institution site, the communication line 50, and the communication unit 16 at the pharmaceutical manufacturer site by a medical results information sending unit 37.

The medical results information updating unit 17 updates a medical results database 18 with the medical results information which is sent from the medical institution and also transmits the received medical results information to the point calculation unit 14.

The point calculation unit 14 calculates evaluation points with reference to point set information such as evaluation point giving conditions for every drug, the evaluation point giving condition being set in the point set database 13, based on the medical results information transmitted through the medical results information updating unit 17 from the medical institution. If the evaluation points are calculated by the point calculation unit 14, the point information is transmitted to the point information updating unit 19.

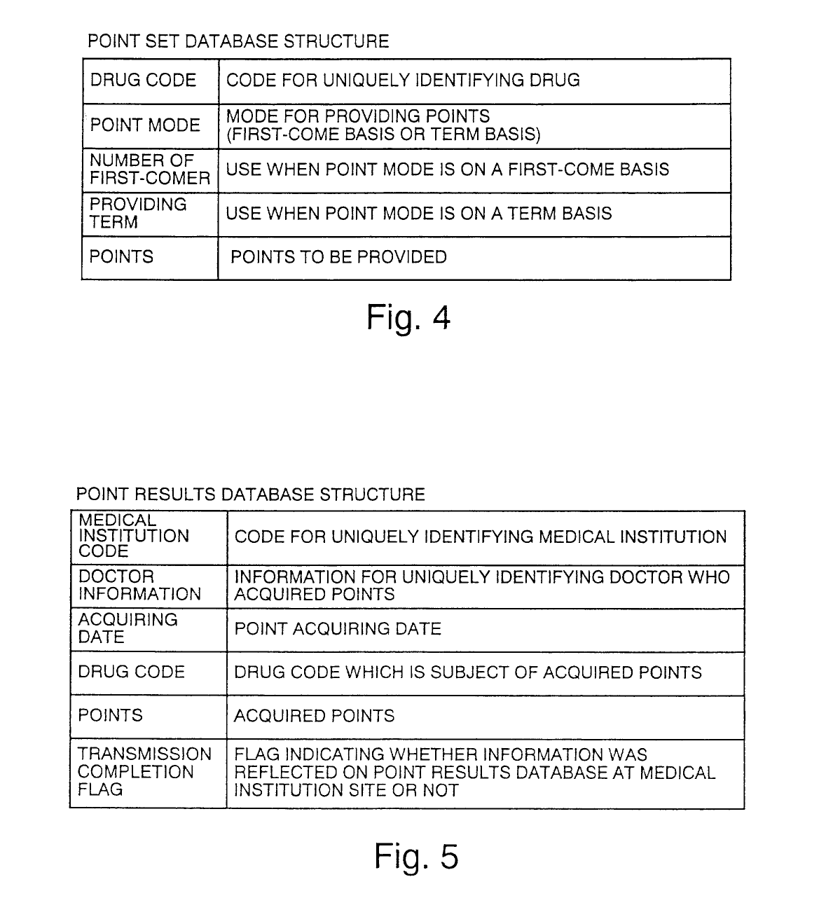

FIG. 4 shows a file structure of the point set database in this embodiment.

As shown in FIG. 4, this point set database stores a drug code which is a subject of points addition, a point mode which indicates that whether a mode for providing points is on a first-come basis or a term basis, the number of a first-corner if the point mode is on the first-come basis, a providing term if the point mode is on the term basis, and points to be provided.

The point information updating unit 19 records the point information, which is transmitted from the point calculation unit 14, in the point results database 20 at the pharmaceutical manufacturer site and also transmits the point information to a point information updating unit 39 at the medical institution site through the communication unit 16 at the pharmaceutical manufacturer, the communication line 50, and the communication unit 38 at the medical institution.

The point information updating unit 39 at the medical institution site records the point information, which is transmitted from the point information updating unit 19 at the pharmaceutical manufacturer site, in a point results database 40. The point results database 40 is a database for recording the point information acquired by the medical institution, in order to match the contents of the point results database 40 with the contents of the point results database 20 at the pharmaceutical manufacturer site.

FIG. 5 shows a file structure of the point results database at the pharmaceutical manufacturer.

As shown in the table, a medical institution code, doctor information, a date of acquiring the points, a drug code which is a subject of points acquisition, acquired points, and a transmission completion flag indicating that whether or not the information was reflected on the point results database at the medical institution site are recorded in the point results database at the pharmaceutical manufacturer.

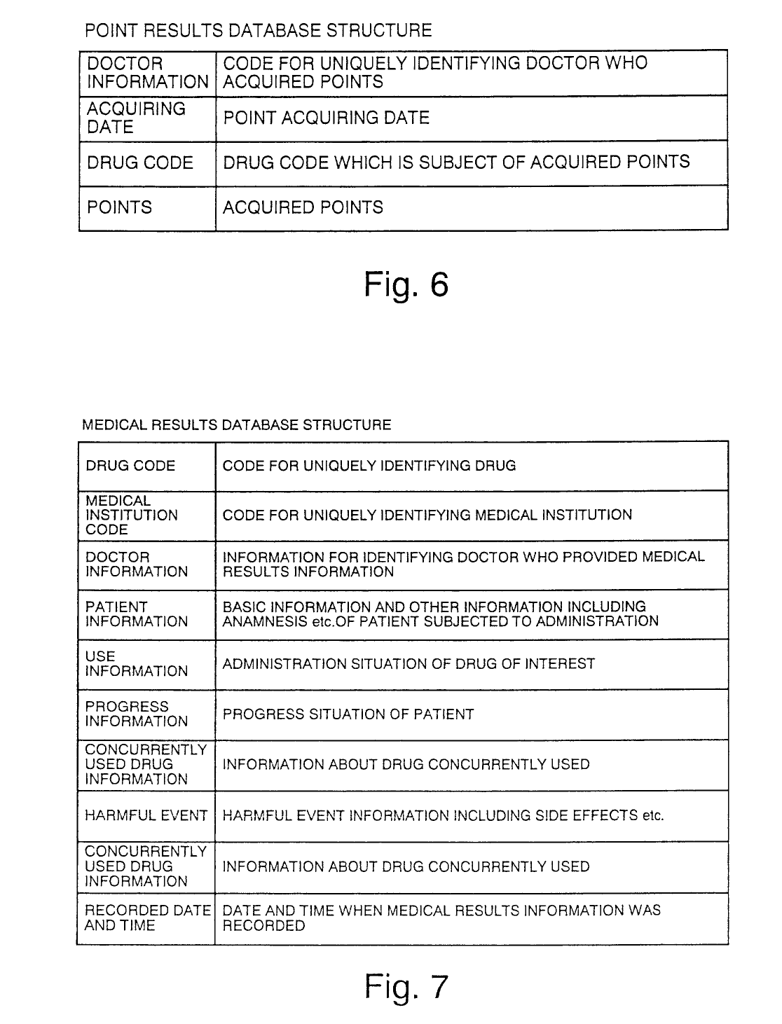

FIG. 6 shows a file structure of the point results database at the medical institution.

As shown in FIG. 6, doctor information, a date of acquiring the points, a drug code which is a subject of points acquisition, and acquired points are recorded in the point results database at the medical institution site.

If the point information is normally recorded in the point results database 40, the point information updating unit 19 at the pharmaceutical manufacturer site is informed through the communication line 50 that the point information is normally updated in the point results database 40. If the point information recorded in the point results database 40 at the medical institution is not normally updated, the point information updating unit 19 at the pharmaceutical manufacturer site is informed through the communication line 50 from the point information updating unit 39 at the medical institution site that the point information is not normally updated, and information such that the medical institution site has yet-to-be sent point information is recorded in the point results database 20. If the point results database 20 at the pharmaceutical manufacturer has yet-to-be sent point information, updating information is periodically sent to the medical institution site, and if the information is normally updated, the yet-be-sent information within the point results database 20 is cleared.

FIG. 7 shows a file structure of the medical results database 18 in this embodiment.

As shown in FIG. 7, medical results information such as a drug code, a medical institution code, information for identifying a doctor who provided medical results information, basic information and other information such as an anamnesis of a patient subjected to administration, an administration situation of a drug of interest, a progress situation of the patient, information about a concurrently used drug, harmful event information such as side effects, information about a concurrently used drug, and a date and time when the medical results information was recorded are recorded in this medical results database.

Next, a process flow from generation of the medical results information at the medical institution site to collection of the medical results information at the pharmaceutical manufacturer site will be described with reference to a flowchart.

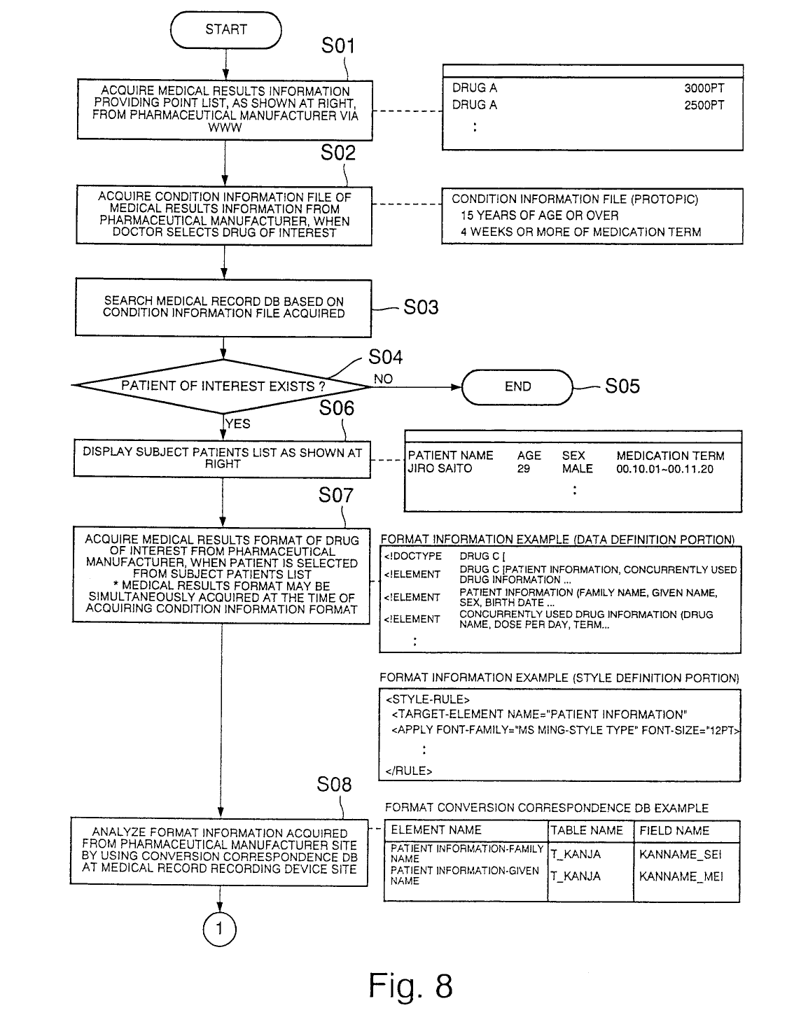

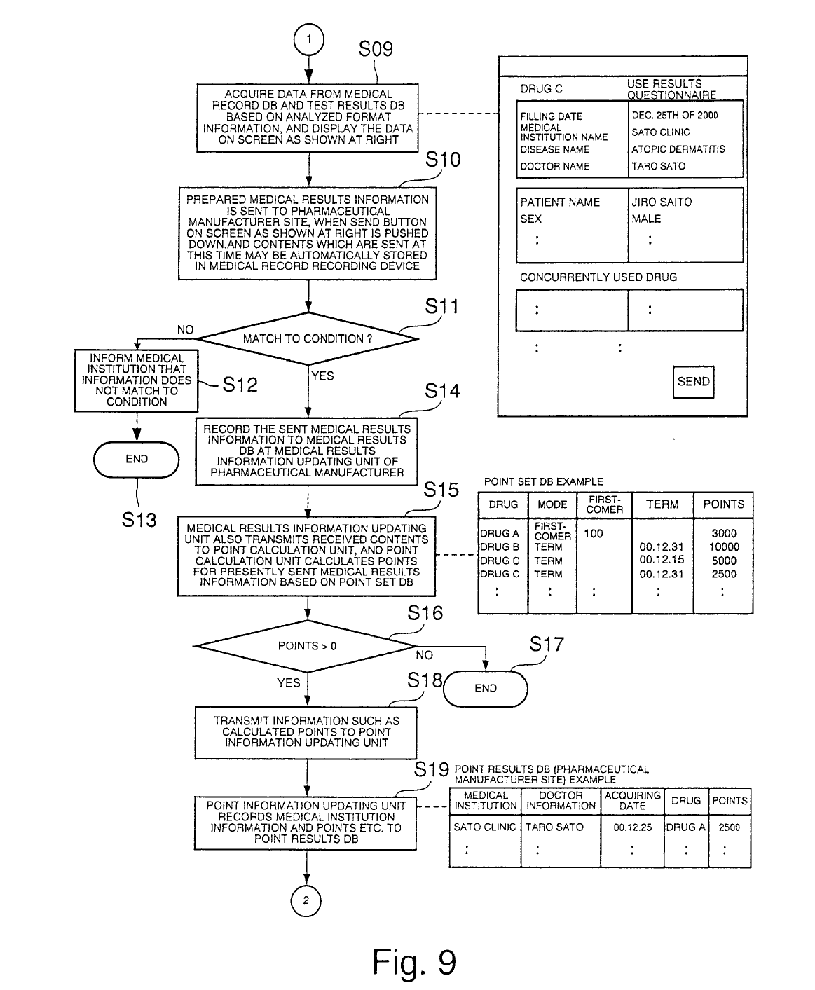

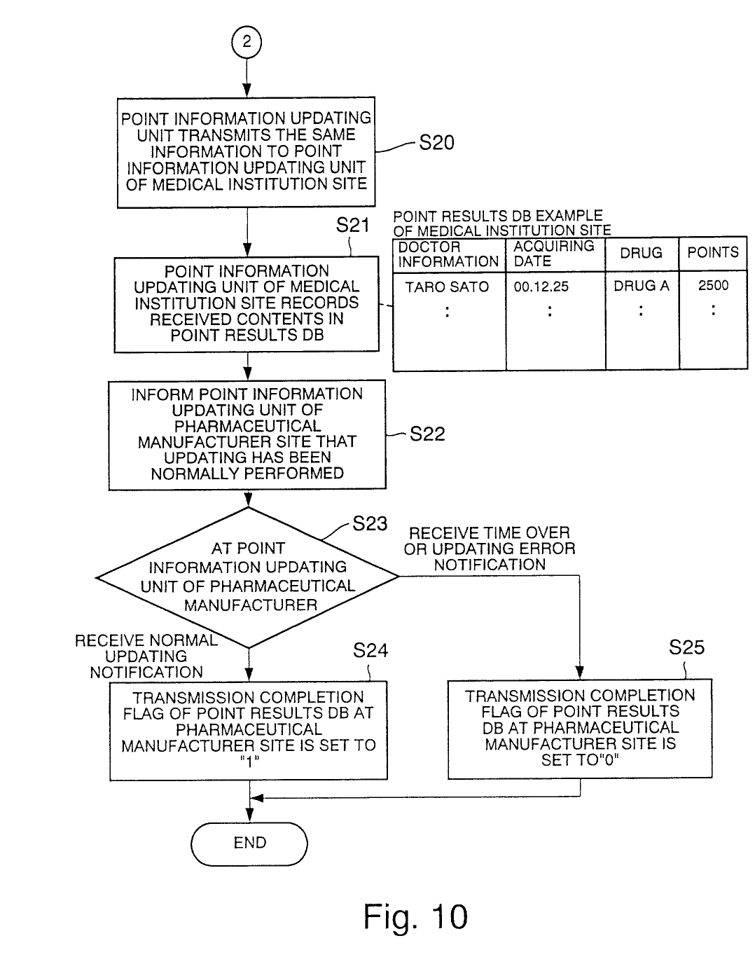

FIG. 8, FIG. 9, and FIG. 10 show a flowchart of a process flow from the generation of medical results information to the collection of the medical results information at a drug information processing device.

A drug information acquiring and displaying unit 32 provided in the medical recorder 10 at the medical institution site (see, FIG. 3) acquires a medical results information providing point list, in which the points to be provided for every drug is described, from the pharmaceutical manufacturer site through the communication line 50 as shown in FIG. 8 (step S01).

When a doctor selects a desired drug among the above described drugs, a condition information file of the medical results information such as “15 years of age or over, and 4 weeks or more of medication term” is acquired from the pharmaceutical manufacturer as shown in FIG. 8 (step S02).

Then the medical record database 31 (see, FIG. 3) is searched, based on the condition which is set in the acquired condition information file (step S03).

Next, whether a patient who corresponds to the above described conditions exists or not is determined (step S04). If a patient corresponding to the above described conditions does not exist as a result of the determination, the process is terminated (step S05). If a patient corresponding to the above described conditions exists as a result of the determination, a subject patients list as shown in FIG. 8 is displayed on a screen (step S06).

On the other hand, if a patient corresponding to the above described conditions does not exist as described above, the process from step S01 can be repeated without terminating the process at step S05.

Next, when the patient is selected from the subject patients list, a medical results format (a documentary form) of a drug of interest as shown in FIG. 8 is transmitted. The medical results format as shown in FIG. 8 comprises a data definition part and a style definition part and is written in an XML (Extensible Markup Language) (step S07). Also, the process may be adapted to be able to simultaneously acquire the medical results format at the time of acquiring the condition information file.

Next, the medical results format information acquired from the pharmaceutical manufacturer site is analyzed by using a format conversion correspondence database 35 at the medical record recording device site (see, FIG. 3) (step S08).

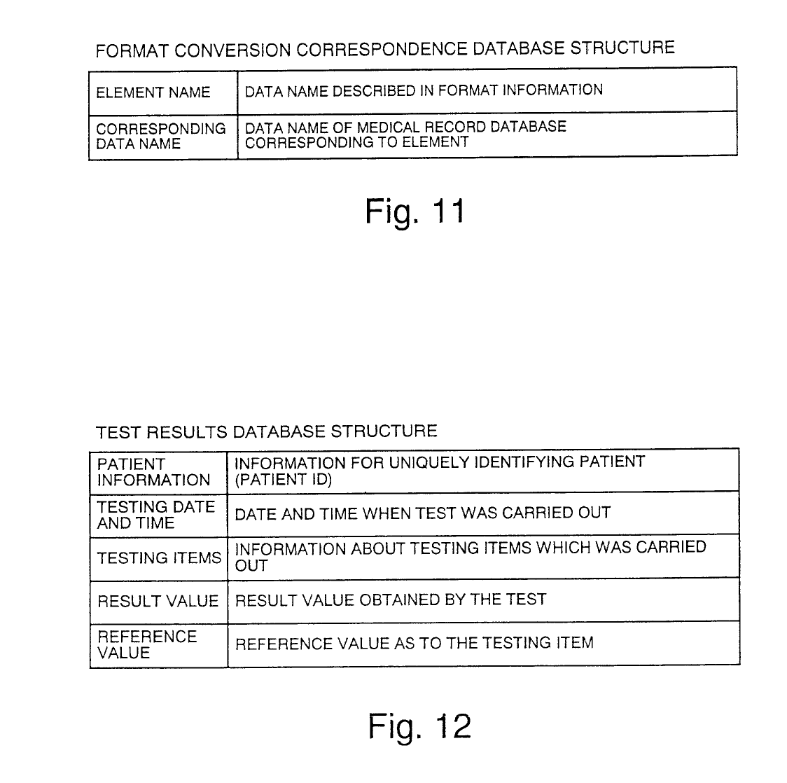

FIG. 11 shows a file structure of a format conversion correspondence database of this embodiment.

As shown in FIG. 11, an element name, a table name, and a field name are recorded in this format conversion correspondence database.

Next, data are acquired from a medical record database and a test results database based on the analyzed medical results format information as shown in FIG. 9, and as for a drug C, a use results questionnaire about a patient, Jiro Saito, prepared by a doctor, Taro Sato, is displayed on a screen as shown in FIG. 9 (step S09). Also, this process may be adapted to be able to make reference to the medical record from the screen.

FIG. 12 shows a file structure of the test results database in this embodiment.

As shown in FIG. 12, patient information, testing date and time, testing items, result values obtained from the test, and reference values as to the testing items are recorded in this test results database.

When a “send button” at a lower right of the screen as shown in FIG. 9 is pushed down, the prepared medical results information is sent to the pharmaceutical manufacturer site. The process may be adapted to be able to automatically save the contents, which is sent at this time, on the medical recorder site (step S10).

Next, at the pharmaceutical manufacturer site whether or not the sent medical results information matches the condition is determined (step S11). If the information does not match the condition as a result of the determination, the medical institution is informed that the information does not match the condition (step S12) and the process is terminated (step S13). If the information matches the condition as a result of the determination, the medical results information updating unit 17 at the pharmaceutical manufacturer site (see, FIG. 3) records the sent medical results information in the medical results database 18 (see, FIG. 3) (step S14). The medical results information updating unit 17 (see, FIG. 3) also transmits the received contents to the point calculation unit 14 (see, FIG. 3). The point calculation unit 14 calculates points as for the presently sent medical results information, based on the point set database 13 (FIG. 9: see, point set DB example) (step S15). In this example, 2500 points are calculated when the drug C is administered to the patient, Jiro Saito.

Then, whether the points are larger than zero or not is determined (step S16), and if the points are zero or less as a result of the determination, the process is terminated (step S17). If the points are larger than zero as a result of the determination, information such as the calculated points is transmitted to the point information updating unit 19 (see, FIG. 3) (step S18).

The point information updating unit 19 records the medical institution information and the points etc. in the point results database 20 (see, FIG. 3). In this way, the point results information as shown in FIG. 9 is recorded in the point results database 20 at the pharmaceutical manufacturer site (step S19).

Also, the process may be adapted to be able to specify a preferential medical institution or the like based on the purchase amount of drugs or the like when the points are calculated and to be able to incorporate a mechanism for adding service points to the evaluation points.

Next, as can be seen from FIG. 10, the point information updating unit 19 transmits the same information to the point information updating unit 39 of the medical institution site (step S20).

Then the point information updating unit 39 at the medical institution site records the point results of 2500 in the point results database 40 for the doctor, Taro Sato, as in the point results DB example at the medical institution site in which the received contents are shown in FIG. 10 (step S21).

If the information is normally updated, the point information updating unit 39 informs the point information updating unit 19 at the pharmaceutical manufacturer site that the information is normally updated (step S22).

At the point information updating unit 19 of the pharmaceutical manufacturer (step S23), if a notice saying that the information has been normally updated is received from the medical institution site, a transmission completion flag of the point results database 20 at the pharmaceutical manufacturer site is set to “1” (step S24) and then the process is terminated. On the other hand, at the point information updating unit 19 of the pharmaceutical manufacturer (step S23), if a notification of time-over or updating-error is received from the medical institution site, a transmission completion flag of the point results database 20 at the pharmaceutical manufacturer site is set to “0” (step S25) and then the process is terminated.

Next, a process for matching the point results database at the pharmaceutical manufacturer site to the point results database at the medical institution site will be described below.

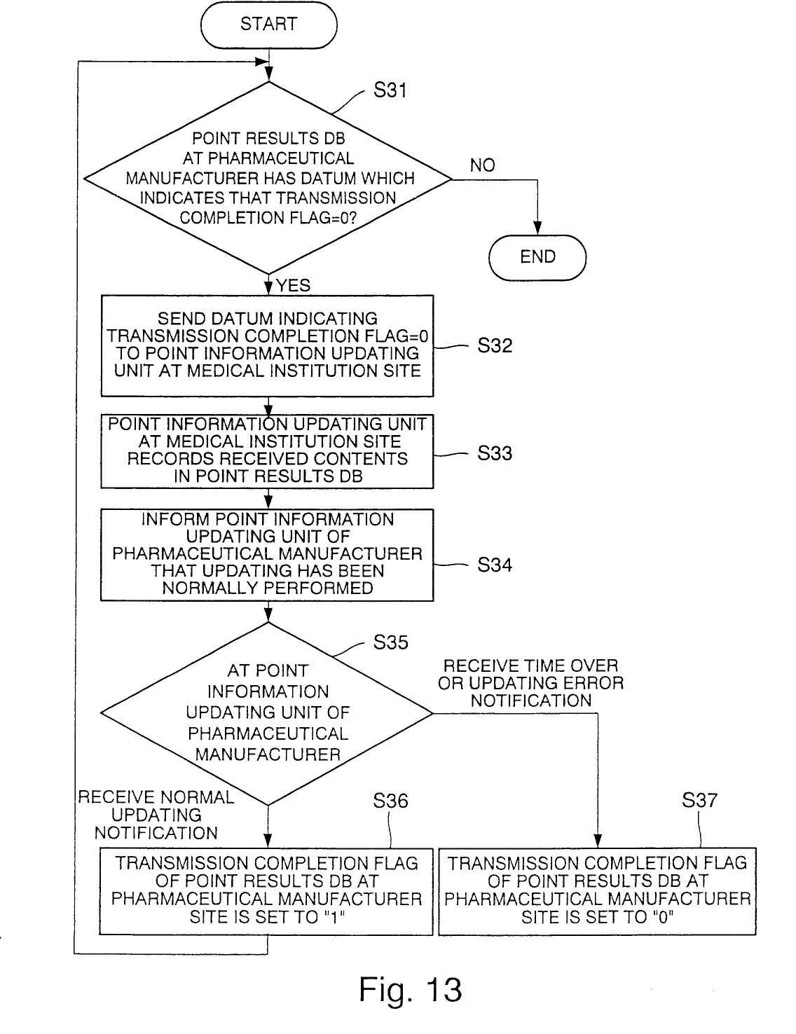

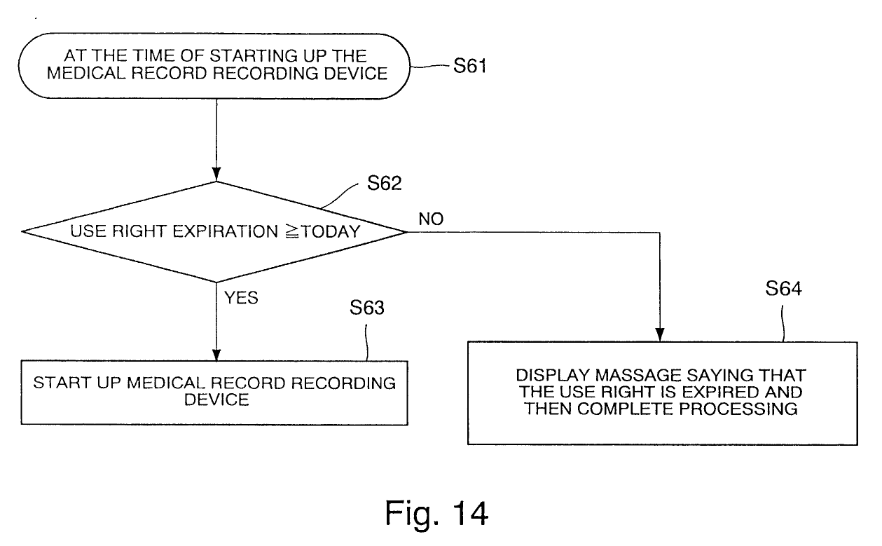

FIG. 13 is a flowchart showing a process for matching the point results database at the pharmaceutical manufacturer site to the point results database at the medical institution site.

As shown in FIG. 13, whether or not the point results database 20 at the pharmaceutical manufacturer site has the data describing the transmission completion flag=“0” is firstly determined (step S31), and if there is no data describing the transmission completion flag =“0” as a result of the determination, the process is terminated (step S37). If the point results database 20 has the data describing that the transmission completion flag=“0” as a result of the determination at step S31, the data describing that the transmission completion flag=“0” is sent to the point information updating unit 39 at the medical institution site (see, FIG. 3) (step S32). The point information updating unit 39 at the medical institution site records the received contents in the point results database 40 (step S33).

If the point results database 40 is normally updated, the point information updating unit 19 (see, FIG. 3) at the pharmaceutical manufacturer site is informed that the point results database 40 is normally updated (step S34).

At the point information updating unit 19 of the pharmaceutical manufacturer site (step S34), if the notice saying that the database has been normally updated is received from the medical institution site, the transmission completion flag in the point results database 20 at the pharmaceutical manufacturer site is set to “1” (step S35), then the process returns to the top and the process from step S31 is repeated. On the other hand, at the point information updating unit 19 of the pharmaceutical manufacturer (step S34), if the notification of time-over or updating-error is received from the medical institution site, the transmission completion flag in the point results database 20 at the pharmaceutical manufacturer site is set to “0”, then the process returns to the top from (step S36) and the process from step S31 is repeated.

The above described process is adapted to be automatically carried out at certain intervals set by a setup file or the like.

Next, a process for renewing an expiration date of the right of using the medical record recording device will be described.

A medical record recording device 30 of this embodiment is such that a medical institution provided with the medical record recording device 30 has a right to use this recorder 30 with a time limit. The drug information processing device 10 is adapted to comprise a use right expiration managing unit 22 for managing an expiration date of the right for the medical institution to use the medical record recording device 30 (provided with the medical record recording device 30), thereby renewing the expiration date of the above described use right based on the accumulated value of the evaluation points given to the medical institution by the point information updating unit 19 (an evaluation point giving unit).

The drug information processing device 10 of this embodiment is also adapted to comprise a use right recording database 23 for recording the expiration date of the right to use the medical record recording device 30 for every medical institution, and to automatically update the expiration date recorded in the use right recording database 23 when the expiration date of the use right is renewed by the use right expiration managing unit 22.

FIG. 14 is a flowchart showing a process when the expiration date of the right to use the medical record recording device is renewed based on the evaluation points.

As shown in FIG. 14, when the medical record recording device is started up (step S61), whether a date of today is equal to or before the expiration date or not is determined (step 62).

The expiration date for using this medical record recording device is defined by a relational expression as follows.

an expiration date=an expiration date presented at the time of purchasing the recorder from a vendor+an extended term based on the medical results information providing points

where “an extended term based on the medical results information providing points” can be acquired from two patterns described below by the medical institution.

“a simple proportional type”: Points on a per-day extension basis are defined. This is automatically calculated by dividing the medical results information providing points by the normal points per-day extension.

“point purchase type”: This is a method in which, using the medical results information providing points acquired and accumulated by the medical institution, the medical institution acquires an extended right to use the medical record recording device as required. The conversion rate is set stepwise, for example, one day for 100 points and five days for 400 points. If the medical institution acquires the medical results information providing points as the extended use right to the medical record recording device, such information is recorded to the medical record recording device.

If the date of today is equal to or before the expiration date as a result of the determination at step S62, the medical record recording device is started up (step S63). And if the date of today is after the expiration day, a message saying that the validity of the use right has been expired is displayed and the process is terminated (step S64).

In this way, a check of the right to use the medical record recording device can be performed.

Next, the medical record recording device 30 of this embodiment will be described with reference to FIG. 3.

The medical record recording device 30 of this embodiment, in which the medical record recording device 30 being installed at the medical institution site and for recording medical records prepared by the medical person in charge in a predetermined medical record database 31 is connected through the communication line 50 to the drug information processing device 10 being installed at the pharmaceutical manufacturer site and for providing the medical institution with drug information about drugs, comprises the drug information acquiring and displaying unit 32 for automatically acquiring the drug information about the new drug from the above described drug information processing device 10 and then displaying the information on a screen, as shown in FIG. 3.

The drug information is stored in the drug database 15 provided in the drug information processing device 10 at the pharmaceutical manufacturer site as shown in FIG. 3

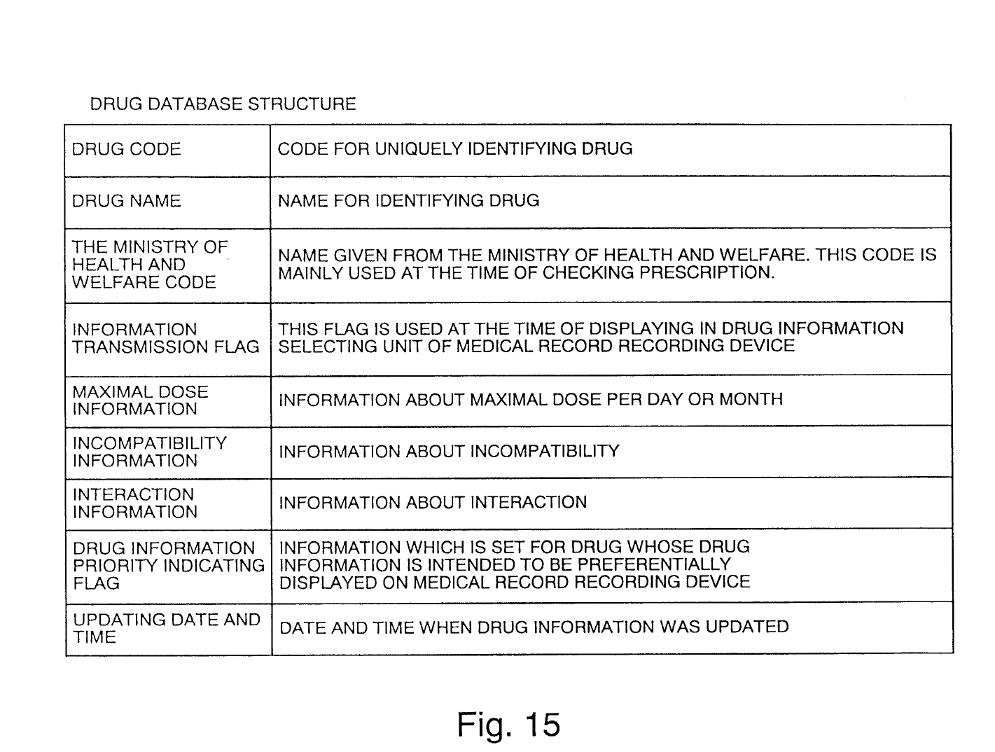

FIG. 15 shows a file structure of the drug database 15 in this embodiment.

As shown in FIG. 15, data such as a drug code, a drug name, the Ministry of Health and Welfare code, an information transmission flag, maximal dose information about the maximal dose per day or month, incompatibility information, interaction information, a drug information priority indicating flag which is set for a drug whose drug information should be preferentially displayed on the medical record recording device, and an updating date and time of the drug information are stored in the drug database 15.

As shown in FIG. 3, the drug information processing device 10 comprises a drug information extracting unit 21, which extracts various information about the drug from the drug information stored in the drug database 15 and the medical results information stored in the medical results database 18.

The extraction of the drug information performed by the drug information processing device 10 may be adapted to be automatically carried out at the time of starting up the drug information processing device 10, or may be adapted to be automatically carried out at the predetermined time intervals, or may be adapted to be carried out under the control of the operator of this drug information processing device, for example.

In addition, the medical record recording device 30 of this embodiment is adapted such that the drug information acquiring and displaying unit 32 automatically acquires drug information about the drug which has been already used and the drug which has been purchased recently by the medical institution, and then displays the acquired information on a screen.

Further, the medical record recording device 30 of this embodiment is adapted such that the drug information acquiring and displaying unit 32 acquires drug information other than that about new drugs which have already had the use results in medical institutions and then displays the acquired information.

This drug information acquiring and displaying unit 32 acquires document information about a drug (interaction information etc.) from the drug information extracting unit 21 at the pharmaceutical manufacturer site through the communication unit 16 at the pharmaceutical manufacturer site, the communication line 50, and the communication unit 38 at the medical institution site, and then records the acquired information in a drug master 41.

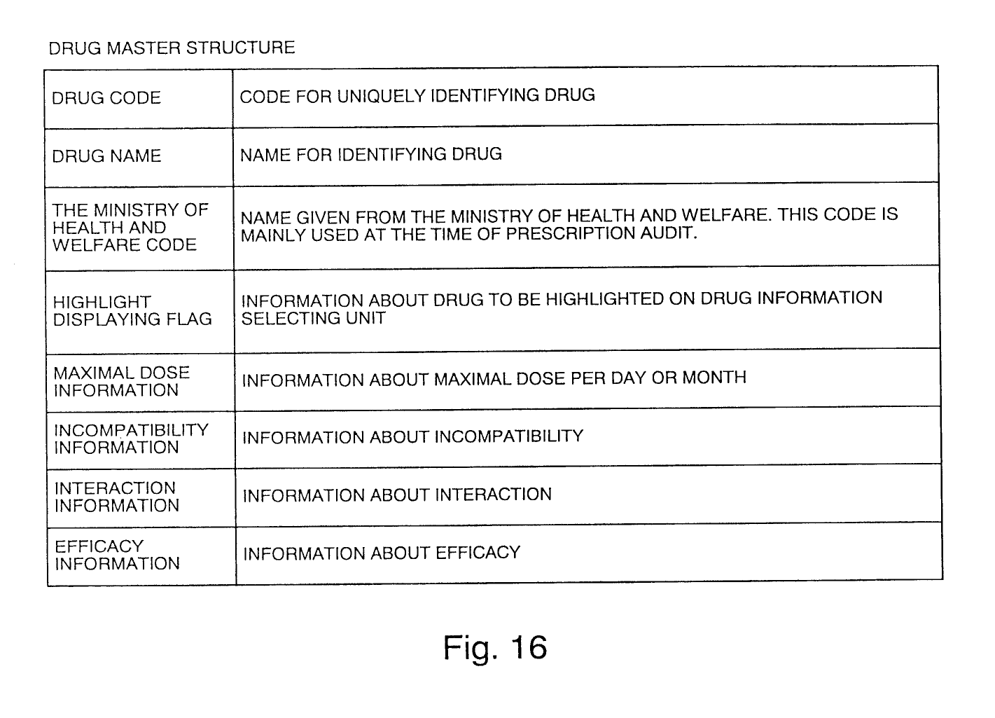

FIG. 16 shows a file structure of the drug master provided in the medical record recording device of this embodiment.

As shown in FIG. 16, a drug code, a drug name, the Ministry of Health and Welfare code, a highlighting flag for identifying a drug which is highlighted at the drug information selecting unit, maximal dose information about the maximal dose per day or month, incompatibility information, interaction information, information about the drug effects and the like are recorded in the drug master.

When the above described information is acquired, it is also possible to make reference to the medical results information stored in the medical results database 18, in addition to acquiring and displaying the drug information. As for a drug which becomes a subject of the points addition performed by providing the medical results information, distinctive information is recorded in the medical results database 18.

The drug information to be displayed on the drug information acquiring and displaying unit 32 is adapted such that the drug information can be efficiently acquired and displayed by narrowing the search to certain specific new drugs of which effects corresponding to those of the existing drugs used in the medical institution or by masking a drug which has been already used in the medical institution.

Next, a process for acquiring the drug information which is performed by the medical record recording device will be described.

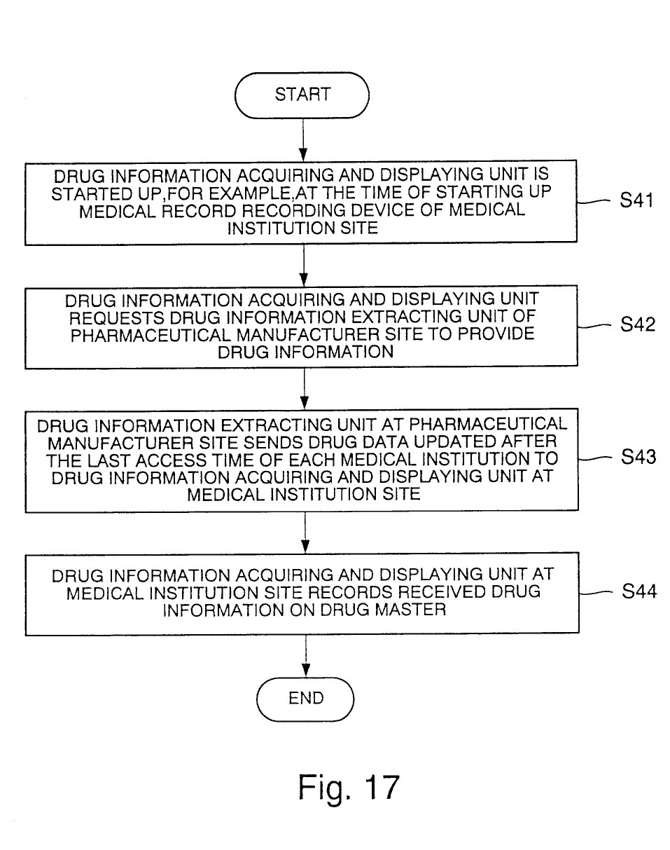

FIG. 17 shows a flowchart for acquiring the drug information by the medical record recording device of this embodiment.

As shown in FIG. 17, at the medical institution site, the drug information acquiring and displaying unit 32 (see, FIG. 3) is started up with predetermined timing, for example, at the time of starting up the medical record recording device 10 (step S41). The start-up timing of the drug information acquiring and displaying unit 32 may be specified arbitrarily.

The drug information acquiring and displaying unit 32 may also be adapted to be automatically started up at the constant time intervals.

The drug information acquiring and displaying unit 32 requests the drug information extracting unit 21 at the pharmaceutical manufacturer site (see, FIG. 3) to provide the drug information (step S42).

The drug information extracting unit 21 at the pharmaceutical manufacturer site sends the drug data, which have been updated after the last access time at each medical institution, to the drug information acquiring and displaying unit 32 at the medical institution (step S43). The extraction may be adapted to be performed based on the access information, with the access information for every medical institution managed by the database.

The drug information acquiring and displaying unit 32 at the medical institution site records the received drug information in a drug master 41 (step S44), and then the process is terminated.

Next, a process for displaying the drug information at the medical record recording device will be described.

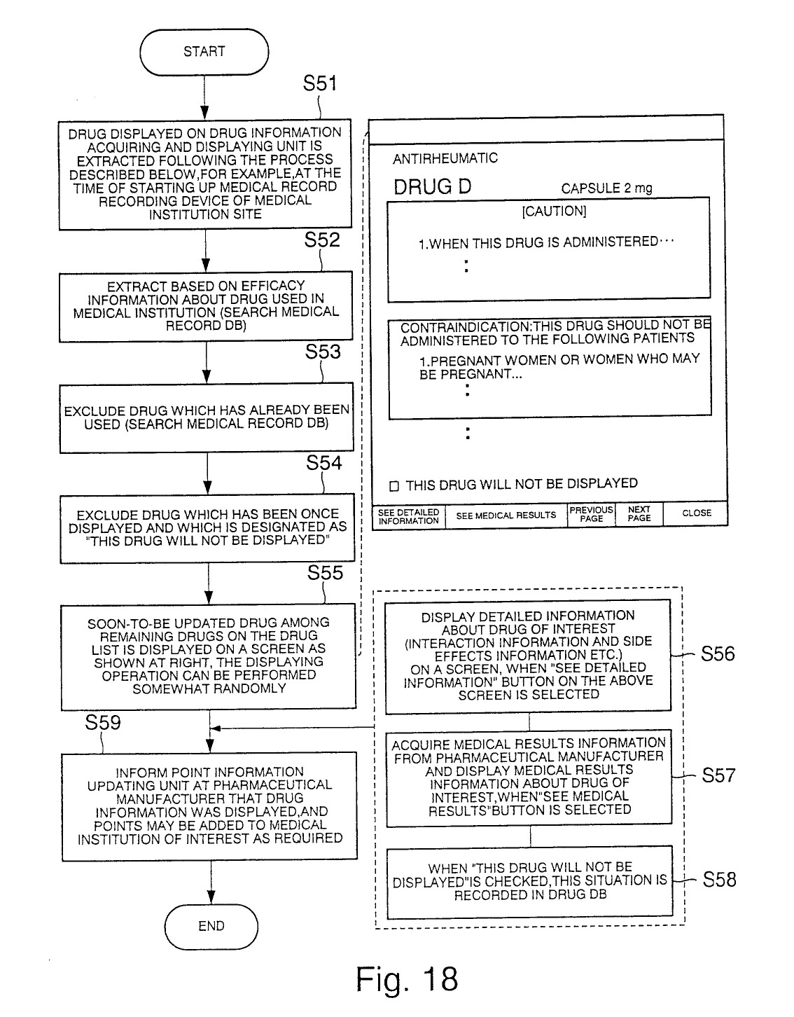

FIG. 18 is a flowchart showing a process for displaying the drug information at the medical record recording device of this embodiment.

As shown in FIG. 18, at the medical institution, a drug which is displayed on the drug information acquiring and displaying unit 32, for example, at the time of starting up the medical record recording device 30 (see, FIG. 3) is extracted following a process described below (step S51).

Drugs used in the medical institution are searched for from the medical record database 31, then drugs are extracted based on the drug effect information (step S52).

In this case, drugs which have been already used are searched for across the medical record database 31, then the corresponding drugs are excluded (step S53). And drugs which have already been displayed once and designated by a doctor as “this drug will not be displayed hereafter” are also excluded (step S54).

Further, drugs soon to be updated among the remaining drugs on the drug list is displayed such that, for example, “Antirheumatic drug Drug D” is on a screen as shown in FIG. 18. In this case, the displaying order of drugs on the screen may be somewhat random (step S55).

When a “see detailed information” button on the screen shown in FIG. 18 is selected, a detailed information screen including interaction information and side effects information is appeared (step S56). When a “see medical results” button is selected, the medical results information is acquired from the pharmaceutical manufacturer and then the medical results information about a drug of interest is displayed (step S57). If a message that “this drug will not be displayed hereafter” is checked, this message is recorded in the drug database (step S58).

Also, the points addition may be performed when the “see detailed information” button is selected at step 56 or when the “see medical results” button is selected at step S57.

Then, the point information updating unit 19 at the pharmaceutical manufacturer site is informed that the drug information has been displayed. At this moment, the points addition may be performed for a medical institution of interest as required (step S59). Then the process is terminated.

The drug information acquiring and displaying unit 32 is also adapted to be able to retain information for discriminating a drug, which becomes a subject of the evaluation points addition performed by offering the medical results information from the medical institution to the pharmaceutical manufacturer, from other drugs in the drug master 41.

The medical record database 31 is a database to which the medical record prepared by a doctor including a symptom of a patient and its progress situation, the details of medication, and the details of procedure are stored, and a medical record input unit 33 is for recording the medical record data input by the input operation of the doctor in the medical record database 31.

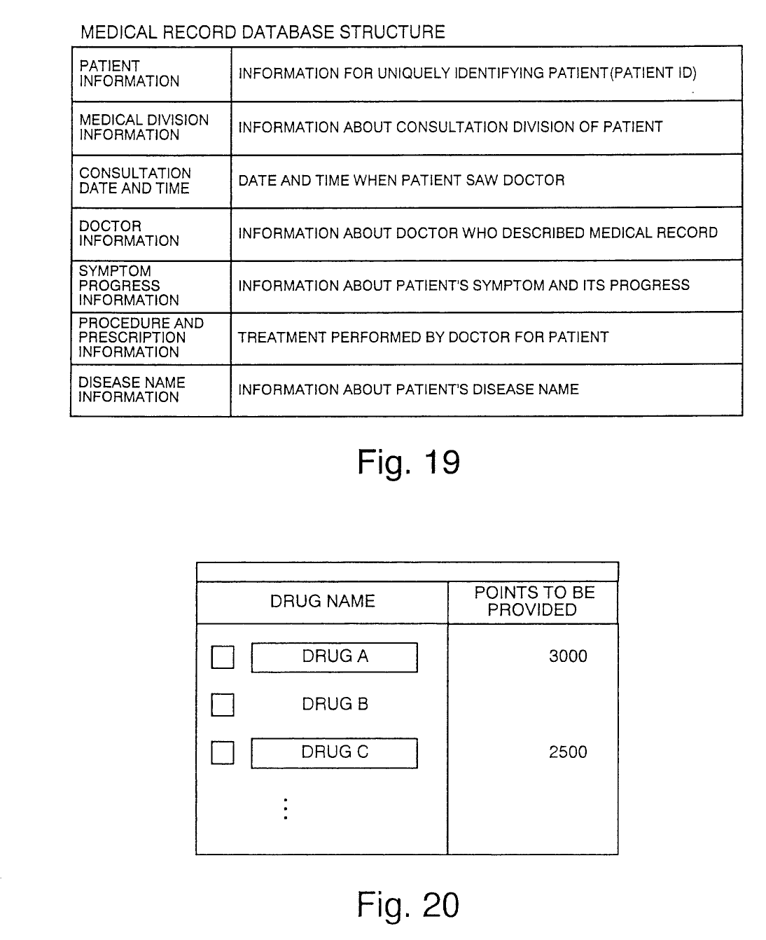

FIG. 19 shows a file structure of the medical record database in this embodiment.

As shown in FIG. 19, patient information, a medical care division, a date and time of consultation, doctor information who describes the medical record, symptom progress information providing a symptom of the patient and its progress, information about procedure and prescription performed for the patient by the doctor, and information about the disease name of the patient are recorded in this medical record database.

Next, a drug information providing system 1 of this embodiment will be described with respect to FIG. 3.

The drug information providing system 1 of this embodiment has a medical record recording device 30 being installed at a medical institution site and for recording medical records prepared by a medical person in charge in a predetermined medical record database 31 as well as for providing a pharmaceutical manufacturer with medical results information about a drug used by the medical institution among medical records recorded in the above described medical record database 31, and a drug information processing device 10 which is installed at a pharmaceutical manufacturer site and is connected through an external network 50 to the medical record recording device 30 and which comprises a point information updating unit 19 for giving evaluation points to the medical institution based on the medical results information provided from the medical record recording device 30 as shown in FIG. 3.

In addition, the drug information providing system of this embodiment is adapted such that the medical record recording device 30 comprises a drug information acquiring and displaying unit 32 for automatically acquiring drug information about a new drug from the drug information processing device 10 and then displaying the information on a screen, and such that the above described point information updating unit 19 gives evaluation points to the medical institution each time the drug information acquiring and displaying unit 32 acquires and displays the drug information about the new drug from the drug information processing device 10.

Further, the drug information providing system is adapted such that the medical record recording device 30 comprises a medical record input unit 33 for inputting medical records including the medical results information in order to record the medical records in the medical record database 31 and has a drug information selecting unit 34 for displaying drug information provided from the drug information processing device 10 on a screen as well as selecting a drug name to be input from the displayed drug information when the medical results information is input by the medical record input unit 33, and the drug information selecting unit 34 displays whether the drug name displayed on the screen is a drug to be a subject for giving points to the medical institution by the point information updating unit 19 or not. Therefore, this drug information selecting unit 34 allows a doctor to select and input the drug information at the time of preparing (inputting) the medical records, with reference to the screen on which the searched drug master 41 is displayed in a certain form required from the doctor. The drug information selecting unit 34 is adapted to highlight the items on the screen, based on the identifying information about the drugs which become subjects of the points addition retained in the drug master 41.

FIG. 20 is an example of a drug list displaying screen which is displayed by the drug information selecting unit of this embodiment.

As shown in FIG. 20, names of three kinds of drugs, that is, Drug A, Drug B, and Drug C and their providing points are shown in a list. The drug names of Drug A and Drug C for which providing points are set are highlighted, while Drug B for which providing points are not set is not highlighted.

In order to display by using the drug information selecting unit 34 whether the drug displayed on the screen becomes a subject of giving points performed by the point information updating unit 19 or not, the drug information processing device 10 comprises a set point acquiring unit 25 for acquiring point setting information for every drug, the point setting information being set on the point setting database 13. Therefore, the point setting information for every drug is adapted to be acquired and transmitted through the communication line 50 to the medical information selecting unit 34 at the medical institution site.

In addition, the drug information providing system is adapted such that the drug information processing device 10 has a condition information transmitting unit 24 for transmitting condition information describing conditions about the medical results information required by the pharmaceutical manufacturer to the medical record recording device 30, and such that the medical record recording device 30 has a subject patient extracting and displaying unit 43 for extracting a patient to be a subject of the medical results information from the medical record database 31 based on the condition information transmitted from the condition information transmitting unit 24 and then displaying the extracted information about the subject patient on a screen.

Further, in this drug information providing system, the drug information processing device 10 has a medical results format transmitting unit 12 for transmitting a format of the medical results information to be prepared by the medical record recording device 30 to the medical record recording device 30, and the medical record recording device 30 has a medical results format converting unit 42 for converting the format of the medical results information transmitted from the medical results format transmitting unit 12 into a format for the medical record database 31, and a medical results information generating unit 36 for editing the medical records recorded in the medical record database 31 to generate the medical results information based on the format of the medical results information transmitted from the medical results format transmitting unit 12 and a format conversion correspondence database 35.

The medical results format transmitting unit 12 of this embodiment sends a format of the medical results information for every drug, as a general data format such as an XML format etc. (see FIG. 8), to the medical institution site.

The medical results format converting unit 42 performs the format analysis based on the format information for preparing the medical results information which is sent from the medical results format transmitting unit 12 to the medical institution site and on the information corresponding to the medical record database 31 at the medical institution site which is set in the format conversion correspondence database 35, and then transmits the analyzed result to the medical results information generating unit 36.

The medical results information generating unit 36 is used for providing information, including harmful events such as curative effects and side effects when the doctor administers new drugs etc. in the medical institution and the concurrently used drugs, for the pharmaceutical manufacturer site. However, since the formats of the medical results information vary with the drugs, the medical results information is adapted to be prepared in a format corresponding to the drug through the medical results format converting unit 42. In addition, the medical results information is automatically expanded from the medical record database 31 by using the format conversion correspondence database 35, so that it becomes possible to easily prepare the medical results information.

The medical results information generated at the medical results information generating unit 36 is sent to the pharmaceutical manufacture site through the communication line 50 by the medical results information transmitting unit 37.

Further, the medical record recording device 30 of this embodiment is given to the medical institution by the point information updating unit 19 (an evaluation point giving unit) and is adapted to have an evaluation point reference unit 44 for making reference to the evaluation points stored in the point results database 40. The medical institution can quickly and at any time refers to the latest value of the evaluation points given to the medical institution by this evaluation point reference unit 44.

Next, one embodiment of the drug information processing program storage medium according to the present invention will be described.

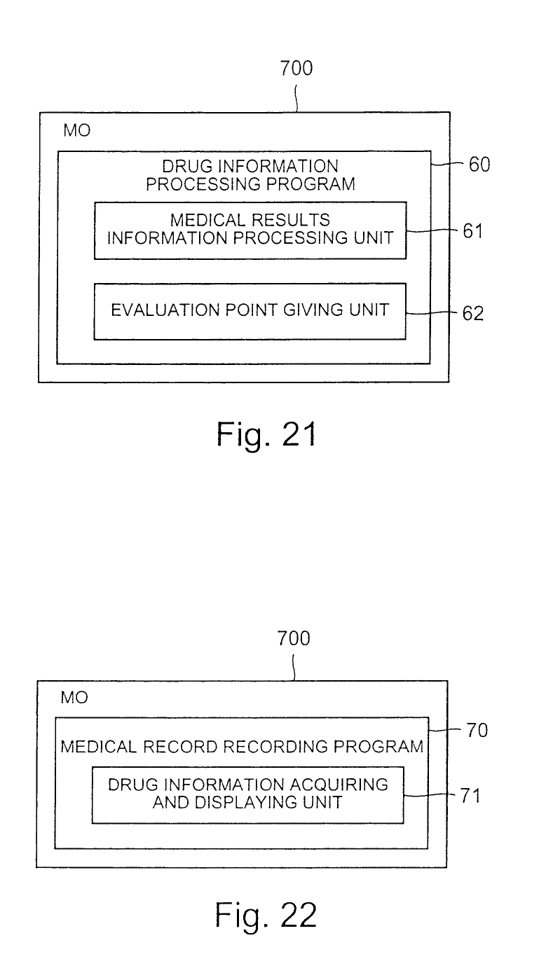

FIG. 21 is a block diagram showing a drug information processing program stored in the drug information processing program storage medium of this embodiment.

As shown in FIG. 21, the drug information processing program 60 is a program which is run on a computer connected through the communication line (see, FIG. 3: reference numeral 50) to the medical record recording device (see, FIG. 3: reference numeral 30) being installed at the medical institution site and for recording medical records prepared by a medical person in charge, the computer being operated as the drug information processing device (see, FIG. 3: reference numeral 10) comprising a medical results information processing unit 61 provided with medical result information about a drug used in the medical institution where the medical record recording device is installed among medical records recorded in the above described medical record recording device in order to carry out processing of the provided medical results information and an evaluation point giving unit 62 for giving evaluation points to the medical institution based on the medical results information provided from the above described medical institution. The drug information processing program 60 shown in FIG. 21 is stored in the MO 700 shown in FIG. 1 and FIG. 2.

The drug information processing program 60 is installed in the computer systems 100 and 200, for example, among the computer systems 100, 200, 300, 400, and 500 described with reference to FIG. 1, and executed to operate the computer as a drug information processing device.

Next, one embodiment of the medical record recording program storage medium according to the present invention will be described.

FIG. 22 is a block diagram showing a medical record recording program stored in the medical record recording program storage medium of this embodiment.

As shown in FIG. 22, the medical record recording program 70 is a program which is run on a computer connected through the communication line 50 (see, FIG. 3: reference numeral 50) to the drug information processing device (see, FIG. 3: reference numeral 10) being installed at the pharmaceutical supplier site and for providing the medical institution with drug information about a drug, the computer being operated as the medical record recording device (see, FIG. 3: reference numeral 30) being installed at the medical institution site and for recording medical records prepared by a medical person in charge in a predetermined medical record database, and this program 70 has a drug information acquiring and displaying unit 71 for automatically acquiring drug information about a new drug from the above described drug information processing device and then displaying the information on a screen. The medical record recording program 70 shown in this FIG. 22 is stored in the MO 700 shown in FIG. 1 and FIG. 2.

The medical record recording program 70 is installed in the computer systems 300, 400, and 500, for example, among the computer systems 100, 200, 300, 400, and 500 described with reference to FIG. 1, and executed to operate the computer as a medical record recording device.

What is claimed is:

1. A drug information processing device which is connected through a communication line to a medical record recording device being installed at a medical institution site and recording medical records prepared by a medical person in charge, comprising:
a medical results information processing unit which is provided with medical results information about a drug used in the medical institution where the medical record recording device is installed among the medical records recorded in the medical record recording device, and which performs processing of the medical results information provided; and
an evaluation point giving unit giving evaluation points to the medical institution based on the medical results information provided from the medical institution.

2. The drug information processing device according to claim 1, wherein the medical record recording device is provided such that a use right of using the medical record recording device is given to a medical institution in which the medical record recording device is installed on a temporary basis, and
wherein the drug information processing device comprises a use right expiration managing unit managing an expiration date of the use right of using the medical record recording device acquired by the medical institution in which the medical record recording device is installed, the use right expiration managing unit renewing the expiration date of the use right based on an accumulated value of evaluation points given to the medical institution by the evaluation point giving unit.

3. The drug information processing device according to claim 2, comprising:
a use right recording database recording an expiration date of a use right of using a medical record recording device for every medical institution,
wherein the use right expiration managing unit automatically updates the expiration date being recorded in the use right recording database when the use right expiration managing unit renews the expiration date of the use right.

4. The drug information processing device according claim comprising:
a point set database previously setting a giving condition of evaluation points for every drug; and
a point calculation unit calculating the evaluation points based on the giving condition of evaluation points stored in the point set database and a providing condition of medical results information provided from the medical institution.

5. A medical record recording device, which is installed at a medical institution site and records a medical record prepared by a medical person in charge in a predetermined medical record database, connected through a communication line to a drug information processing device being installed at a pharmaceutical supplier site and providing the medical institution with drug information about a drug, comprising:
a drug information acquiring and displaying unit automatically acquiring drug information about a new drug from the drug information processing device and then displaying the acquired information on a screen.

6. The medical record recording device according to claim 5, wherein the drug information acquiring and displaying unit acquires and displays drug information about a drug which has been used in the medical institution and a drug which has been recently purchased by the medical institution.

7. The medical record recording device according to claim 5, wherein the drug information acquiring and displaying unit acquires and displays drug information other than drug information about a new drug which has already been used in the medical institution.

8. The medical record recording device according to claim 5, comprising:
an evaluation point reference unit making reference to evaluation points given from the evaluation point giving unit to a medical institution.

9. A drug information providing system, comprising:
a medical record recording device being installed at a medical institution site and recording a medical record prepared by a medical person in charge in a predetermined medical record database as well as providing a pharmaceutical supplier with medical results information about a drug used in the medical institution among medical records recorded in the medical record database; and
a drug information processing device, which is installed at a pharmaceutical supplier site and is connected through a communication line to the medical record recording device, having an evaluation point giving unit giving evaluation points to the medical institution based on the medical results information provided from the medical record recording device.

10. The drug information providing system according to claim 9, wherein the medical record recording device comprises a drug information acquiring and displaying unit automatically acquiring drug information about a new drug from the drug information processing device and then displaying the acquired information on a screen, and
wherein the evaluation point giving unit gives evaluation points to the medical institution each time the drug information acquiring and displaying unit acquires and displays the drug information about the new drug from the drug information processing device.

11. The drug information providing system according to claim 9, wherein the medical record recording device comprises:
a medical record input unit inputting a medical record including the medical results information in order to record the medical record in the medical record database; and
a drug information selecting unit displaying drug information provided from the drug information processing device on a screen as well as selecting a drug name to be input from the displayed drug information when the medical results information is input by the medical record input unit, and
wherein the drug information selecting unit displays whether or not the drug displayed on the screen is a drug to be a subject of point giving performed by the evaluation point giving unit.

12. The drug information providing system according to claim 9, wherein the drug information processing device has a condition information transmitting unit transmitting condition information describing conditions about medical results information required from a pharmaceutical supplier to the medical record recording device, and
wherein the medical record recording device has a subject patient extracting and displaying unit extracting a patient to be a subject of the medical results information from the medical record database based on the condition information transmitted from the condition information transmitting unit, and then displaying information about the extracted subject patient on a screen.

13. The drug information providing system according to claim 9, wherein the drug information processing device has a medical results format transmitting unit transmitting a format of medical results information which should be prepared by the medical record recording device to the medical record recording device, and
wherein the medical record recording device has a format conversion correspondence database converting the format of medical results information transmitted from the medical results format transmitting unit into a format for the medical results database, and has a medical results information generating unit editing the medical record recorded in the medical record database and then generating the medical results information based on the format of medical results information transmitted from the medical results format transmitting unit and the format conversion correspondence database.

14. A drug information processing program storage medium which stores a drug information processing program, wherein the drug information processing program is run on a computer connected through a communication line to a medical record recording device being installed at a medical institution site and recording a medical record prepared by a medical person in charge, and wherein the computer is operated as a drug information processing device comprising a medical results information processing unit provided with medical results information about a drug used in the medical institution where the medical record recording device is installed among medical records recorded in the medical record recording device and carrying out processing of the provided medical results information, and an evaluation point giving unit giving evaluation points to the medical institution based on the medical results information provided from the medical institution.

15. A medical record recording program storage medium which stores a medical record recording program, wherein the medical record recording program is run on a computer connected through a communication line to a drug information processing device being installed at a pharmaceutical supplier site and providing a medical institution with drug information about a drug, and the computer is operated as a medical record recording device being installed at the medical institution site and recording a medical record prepared by a medical person in charge in a predetermined medical record database, and
wherein the medical record recording program has a drug information acquiring and displaying unit automatically acquiring drug information about a new drug from the drug information processing device and then displaying the acquired information on a screen.
